(19) United States
(12) Patent Application Publication
(10) Pub. No.: US 2003/0071405 A1
(43) Pub. Date: Apr. 17, 2003

(54) Vacuum device for holding workpieces

(76) Inventor: Christopher Alois Miksovsky, Stanford, CA (US)

Correspondence Address: CHRISTOPHER ALOIS MIKSOVSKY, 1632 PAGE STREET, SAN FRANCISCO, CA, 94117, US

(21) Appl. No.: 10/210,319

(22) Filed: Aug. 1, 2002

Related U.S. Application Data
(60) Provisional application No. 60/309,611, filed on Aug. 2, 2001.

(51) Int. Cl. B23Q 3/02

(52) U.S. Cl. 269/95

(57) ABSTRACT

A vacuum pump operated vacuum pad (35) is utilized as a vacuum base (22) for a workpiece clamping mechanism (11). In one embodiment, the clamping mechanism (11) is solidly connected to a rigid base plate (36) which is solidly affixed to the vacuum pad (35). In use, the vacuum pad (35) is vacuum bonded to a mounting surface (23), thereby rigidly but temporarily anchoring the clamping mechanism (11) in place so that objects may be secured therein and operated on.

### CROSS REFERENCE TO RELATED APPLICATION

This application is entitled to the benefit of Provisional Patent Application No. 60/309,611, filing date Aug. 2, 2001.

### BACKGROUND

1. Field of Invention

This invention relates to a workpiece holding device with a vacuum base.

2. Description of Prior Art

In the course of many different activities—hobbies, construction projects, home improvement, etc.—it is often necessary to securely hold an object so that some action may be done to it. Holding a workpiece in a vise or other clamping mechanism permits the worker to safely operate on the object. If there is no suitable work holding device, people are often forced to hold objects in an unsafe manner (with their hands, underneath their feet, etc.). To function adequately, the workpiece holder must itself be sufficiently secured so that the user can apply work-related forces to the workpiece. For example, when cutting a piece of wood, the workpiece holder must be solidly-affixed enough to resist the back and forth forces of a saw blade. Or, when drilling a hole in a piece of pipe or wood, the workpiece holder must resist both the torsional forces of the drill, and the downward force of the drill bit into the workpiece. However, hobbies, construction projects, home improvement, and other such projects usually only require temporary workpiece holding. When the project or task is complete, it is no longer necessary to have the workpiece holder immediately ready for use. There are also situations where work is done in the field, and the workpiece holder is only necessary for a short period of time. So the two main workpiece holding needs are solid affixation, and temporary affixation. These two criteria or at odds with one another: The more solidly you affix the workpiece holder (perhaps with large bolts into a relatively immoveable object like a workbench), the more permanent a fixture that workpiece holder becomes. The more temporary you make the affixation, the less able it is to be solid.

Workpiece holding manufacturers have tried to address this need. There are numerous “clamp-on” style workpiece holders that employ a clamp that is screwed onto a table edge or other protruding surface. These screw clamps mar the surface they're being clamped to, and do not generate a very large amount of force—as such, they are limited to use on small vise type mechanisms. Some other manufacturers have produced vacuum-based workholding mechanisms that will adhere to a smooth, non-porous surface. These workpiece holders employ a mechanical action to lift the center of a flexible rubber membrane away from the surface beneath it, thereby creating a vacuum which then holds the membrane and workpiece holder upon it down. Effectively, these vacuum base holders use an increase in cavity volume to create a vacuum. These work holders do not mar the surface they're being attached to. However, as with the clamp-on work holders, they do not generate large holding forces so they're limited to use with light duty work holding needs. The larger forces involved with medium- and heavier-duty tasks will dislodge these devices from their mounting surfaces. Because they can only facilitate light duty tasks, these vacuum work holders are small in size and are primarily used for hobby, craft and similar work. These vacuum work holders also give no indication of the vacuum force present—in use, it is not uncommon for there to be a slow leak in the vacuum seal. So, you can be using the workpiece holder thinking there's sufficient gripping force when it all-of a-sudden frees itself from the surface. This can be frustrating and dangerous.

The following prior art reflects the state of the art of which the applicant is aware and is included herewith to discharge applicant's acknowledged duty to disclose relevant prior art. It is stipulated, however, that none of these references teach singly nor render obvious when considered in any conceivable combination the nexus of the instant invention and as particularly claimed.

| U.S. Pat. No. | U.S. Patents Issue Date | Inventor |
|---|---|---|
| 1,065,307 | Jun. 17, 1913 | Evertts |
| 1,313,307 | Aug. 19, 1919 | Locraft |
| 2,394,365 | Feb. 5, 1946 | Seamans |
| 2,420,811 | May 20, 1947 | Brewster, et al. |
| 3,061,351 | Oct. 30, 1962 | Johnson |
| 3,159,370 | Dec. 1, 1964 | Rubenstein |
| 3,180,604 | Apr. 27, 1965 | Hammer |
| 3,207,503 | Sep. 21, 1965 | Clover et al. |
| 3,240,525 | Mar. 15, 1966 | Wood |
| 3,659,678 | May 2, 1972 | Hall, Jr. |
| 3,770,259 | Nov. 6, 1973 | Wagreich |
| 3,833,230 | Sep. 3, 1974 | Noll |
| 3,913,964 | Oct. 21, 1975 | Lukeman |
| 4,214,785 | Jul. 29, 1980 | Broch |
| 4,382,588 | May 10, 1983 | Vovk et al. |
| 4,457,503 | Jul. 3, 1984 | Connor |
| 4,582,460 | Apr. 15, 1986 | Silverberg et al. |
| 5,042,772 | Aug. 27, 1991 | Madjeski |
| 5,083,758 | Jan. 28, 1992 | Duke |
| 5,135,207 | Aug. 4, 1992 | Bleaney |
| 5,383,751 | Jan. 24, 1995 | Wheetley et al. |
| 5,728,258 | Mar. 17, 1998 | Chung |
| 5,785,304 | Jul. 28, 1998 | Little |
| 5,820,116 | Oct. 13, 1998 | Haese |
| 6,039,371 | Mar. 21, 2000 | Smith |
| 6,413,022 | Jul. 2, 2002 | Sarh |

By combining technology disclosed in U.S. Pat. No. 3,240,525 with a clamping mechanism, my invention achieves very high surface gripping strength (theoretically, once the vacuum pad has been pumped to create a vacuum, it would require over 500 lbs of force to pull the pad off the mounting surface) and an equally high level of temporariness. The ability to quickly and easily affix my invention to a surface without marring or damaging the surface, while creating a holding force on par with permanent workpiece holding fixtures by evacuating air rather than by simply expanding a volume or compressing a suction cup to expel air, is new and unique I believe.

### SUMMARY

The invention, an improved workpiece holder features a clamping mechanism mounted to a base pad made of a resilient, elastomeric material. A small, hand-operated vacuum pump also mounted to the invention is connected to the resilient base pad and can remove air trapped between the pad and the mounting surface. This arrangement permits the user to set the invention on any substantially smooth surface (either horizontal, vertical, inverted, or at any angle in between), pump the vacuum pump to evacuate the air beneath the rubber pad and thereby create an unexpectedly strong grip of the invention onto the surface. With the invention solidly affixed, the user is free to use the workpiece holder to safely clamp in objects to be worked on or that otherwise need to be held. The vacuum pump design gives the user a general indication of the vacuum force present at any time. Upon completion of the task, the user depresses an air release valve, thereby allowing air to reenter under the pad and eliminating the vacuum seal. The user can then easily store the invention out of harm's way or transport it.

### OBJECTS AND ADVANTAGES

Accordingly, several objects and advantages of the invention are:

(a) to provide an improved workpiece holding device;

(b) to provide a means of temporarily securing a workpiece holder onto any substantially smooth surface;

(c) to provide a temporary workpiece holder that will not mar the surface it is being ground to;

(d) to provide a workpiece holder with a gripping strength on par with permanently-mounted devices of a similar nature that the user can transport or store in a different location out of harm's way when not in use;

(e) Still further objects and advantages will become apparent from a study of the follow description and the accompanying drawings.

### DRAWING FIGURES

FIG. 1 is a perspective view of a workpiece holding device in accordance with the invention, from the air-release-valve side of the vacuum pump.

FIG. 2 is a perspective view of a workpiece holding device in accordance with the invention, from the piston side of the vacuum pump.

FIG. 3 is a detail view of the connection between the vacuum pump and the base pad.

FIG. 4 is a perspective view from the underside of the base pad.

FIG. 5 is an exploded view of the invention.

FIG. 6 shows an alternate embodiment of the invention wherein the vacuum pump is positioned below a base plate to which the clamping mechanism has been attached.

FIG. 7 shows an alternate embodiment of the invention wherein the vacuum pump is a removable element.

FIG. 8 shows an alternate embodiment of the invention wherein the clamping mechanism is a removable element. In this figure, the clamping mechanism is disconnected from the vacuum pad base.

FIG. 8a shows an alternate embodiment of the invention wherein the clamping mechanism is a removable element. In this figure, the clamping mechanism is connected to the vacuum pad base.

FIG. 9 shows an alternate embodiment of the invention wherein the vacuum pump is integrated into the base unit itself.

FIG. 10 shows an alternate embodiment of the invention wherein there is a plurality of vacuum pads to affix the clamping mechanism to the mounting surface.

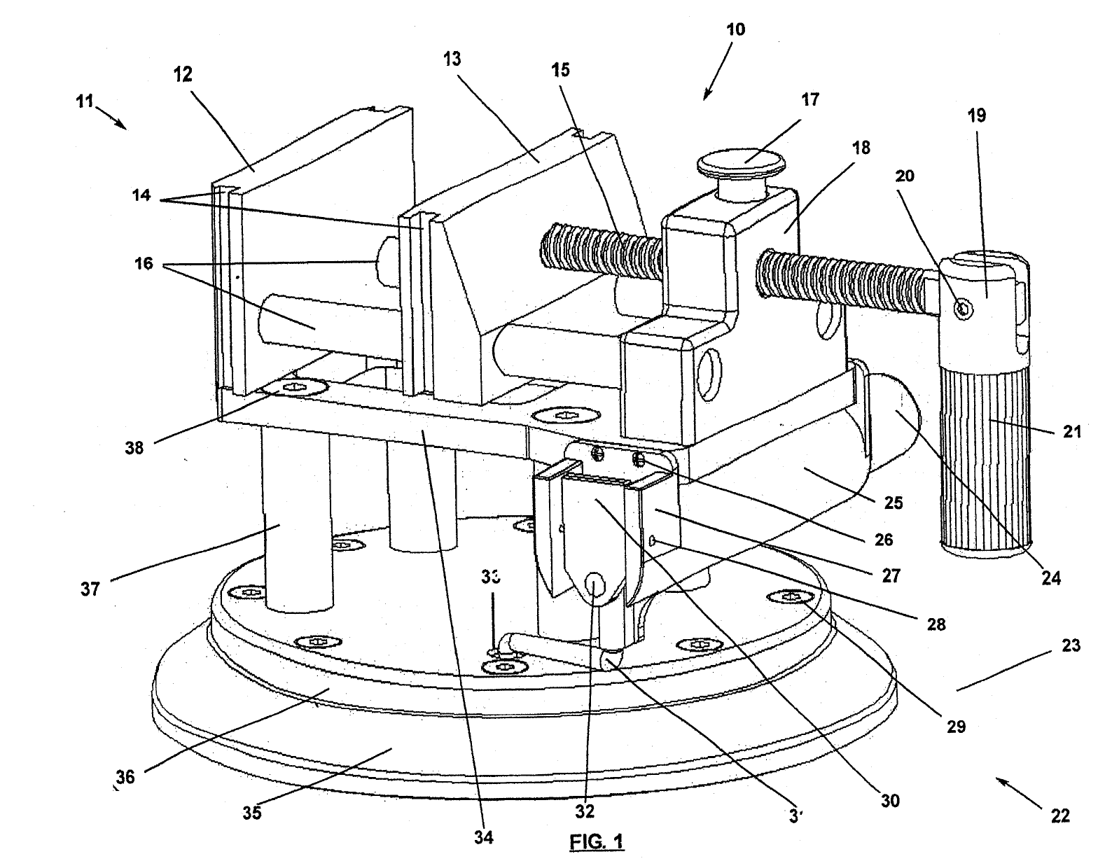

### DESCRIPTION—FIGS. 1-5—PREFERRED EMBODIMENT

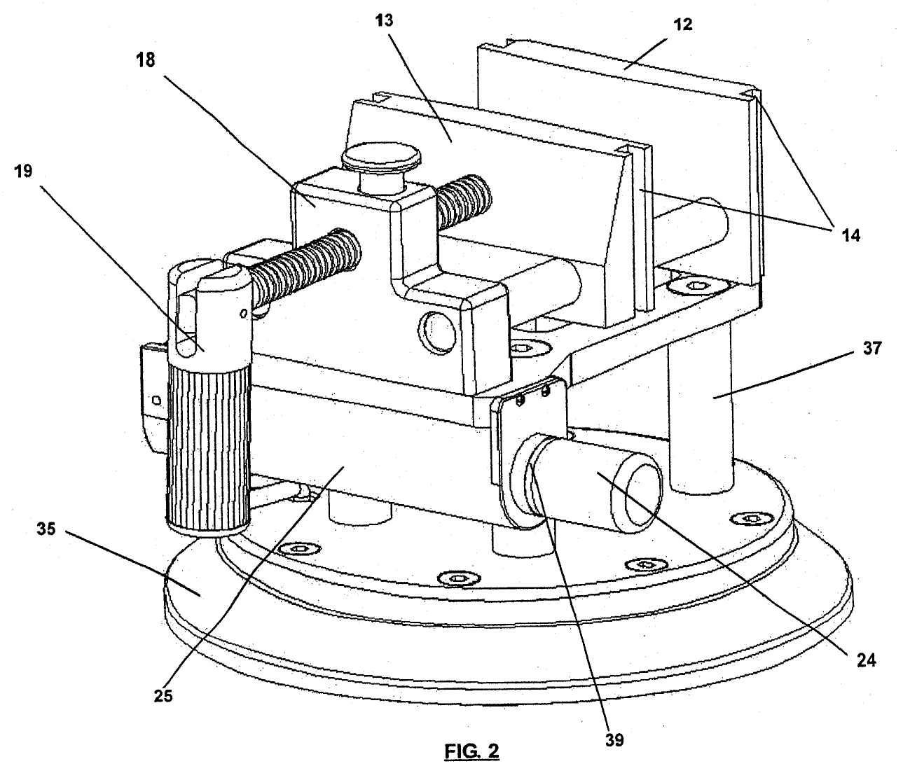

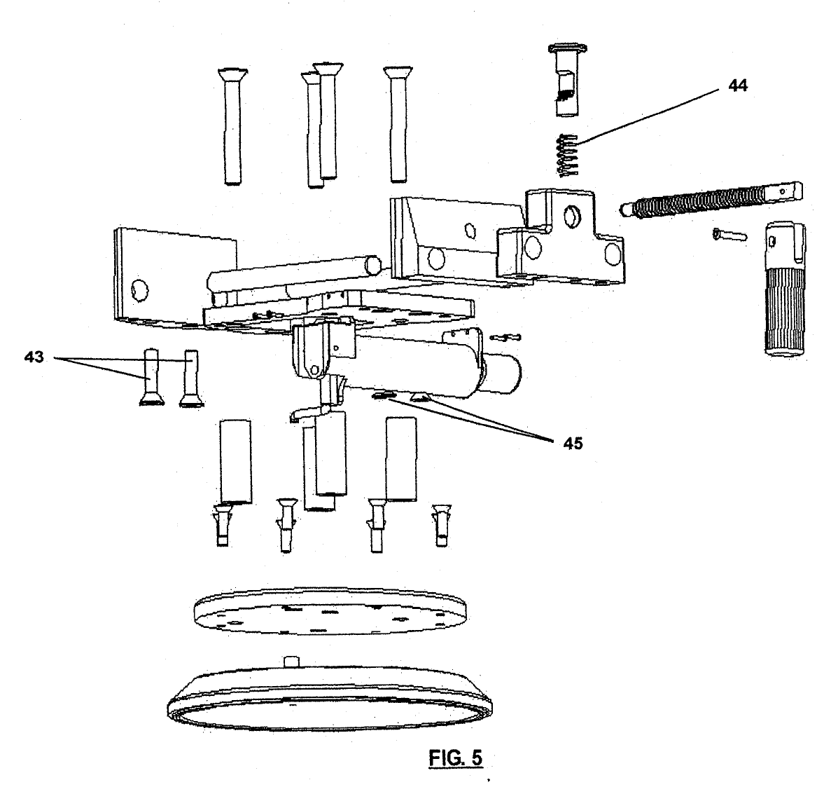

Considering the drawings, wherein like reference numerals denote like parts throughout the various drawing figures, reference number 10 is directed to a vacuum device for holding workpieces according to a first embodiment of the present invention. The vacuum device for holding workpieces is formed of two main elements; a clamping workpiece mechanism 11, and vacuum base 22. A first embodiment of the invention is illustrated in FIGS. 1 and 2 (perspective) and in FIG. 5 (exploded view).

In FIG. 1, the clamping mechanism 11 comprises a fixed clamping jaw 12 oriented to oppose a moveable clamping jaw 13. Both jaw 11 and jaw 12 feature accessory jaw mounting channels that would permit accessory jaw plates having different surfaces or profiles to grip and hold specific objects to be slid on the jaws. A lead screw 15 is fastened to moveable clamping jaw 13 and mates with halfnut 17 that is normally forced to connect with the leadscrew 15 by pressure exerted from halfnut spring 45. Halfnut 17 and spring 45 are situated in brace block 18. Leadscrew 15 passes through brace block 18 and is connected to handle 19 at handle pivot 20. Handle 19 features a textured surface 21.

A vacuum base 22 comprises a suction cup or vacuum pad 35 made of pliant rubber or any suitable elastomer having equivalent properties. An air space or chamber 41 is formed in the inverted vacuum pad 35 and when the air is evacuated, the vacuum pad 35 collapses by the action of atmospheric pressure and seals against any substantially smooth mounting surface 23.

A piston 24 is manually reciprocated in cross tube 25 to draw air from chamber 41 through tube 31 to be exhausted to the atmosphere. The cross tube is fastened to the clamp mechanism base plate 34 with vacuum pump fasteners 26. A finger operated valve 32 protected by valve shield 27 that pivots on valve pivot 28 actuated by air release valve knob 30 can be operated to admit air through valve 32 into chamber 41 to break the vacuum.

A base plate 36 made of metal, plastic or other rigid material is fastened to the vacuum pad 35 with base plate fasteners 29. Base plate pad access hole 33 permits tube 31 to seal with vacuum pad 35. The workpiece clamping mechanism 11 is connected to base plate 36 by means of standoff fasteners 38. Standoffs 37 elevate the workpiece clamping mechanism 11 over the base plate 36.

In FIG. 2, the vacuum pump piston 24 features a vacuum pressure level indicator 39.

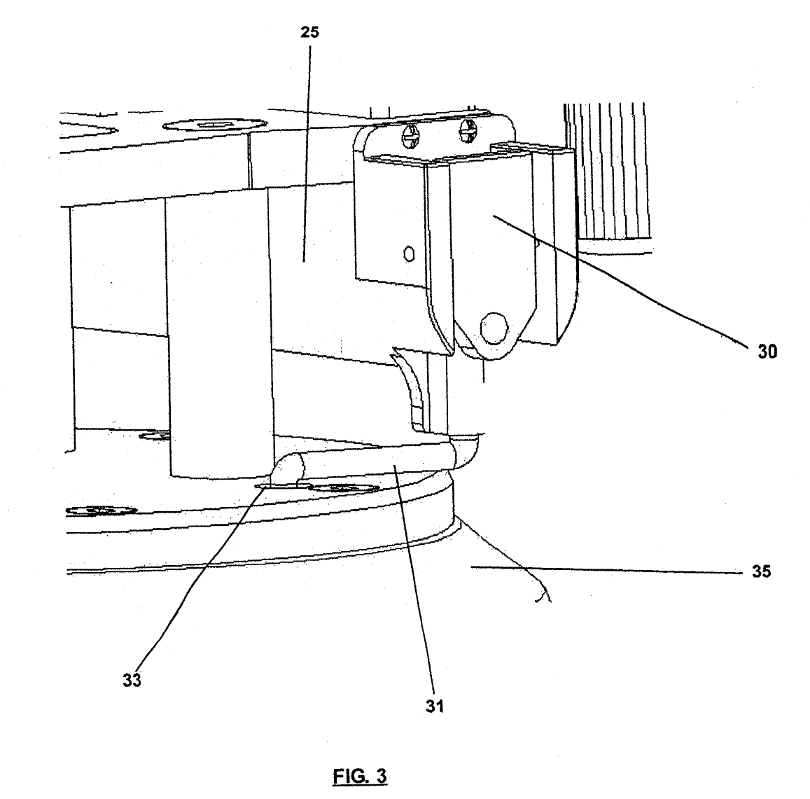

FIG. 3 is a close up detail drawing of the air release valve knob 30, tube 31, base plate pad access hole 33, cross tube 25, and vacuum pad 35. This drawing clarifies the joining of the vacuum pump with the vacuum pad 35.

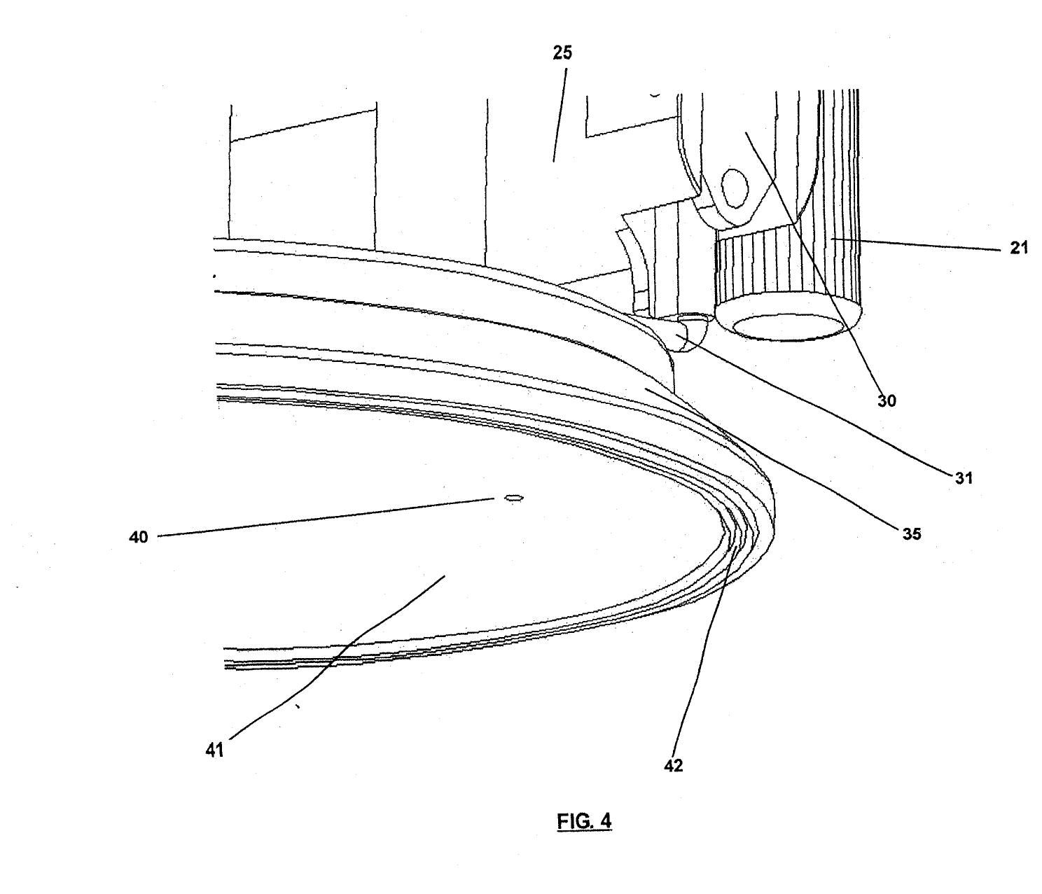

FIG. 4 shows an air evacuation hole 40 through which air can pass from the air chamber 41 through the vacuum pad 35, tube 31 and valve 32. The vacuum pad 35 features small base pad air seal protrusion 42 made of pliant rubber or any suitable elastomer having equivalent properties.

FIG. 5 is an exploded view of the invention and shows fixed jaw mounting fasteners 43 that join clamp mechanism base plate 34 to fixed clamping jaw 12. This view also shows the halfnut spring 44 housed in brace block 18. This figure also shows the brace block mounting fasteners 45.

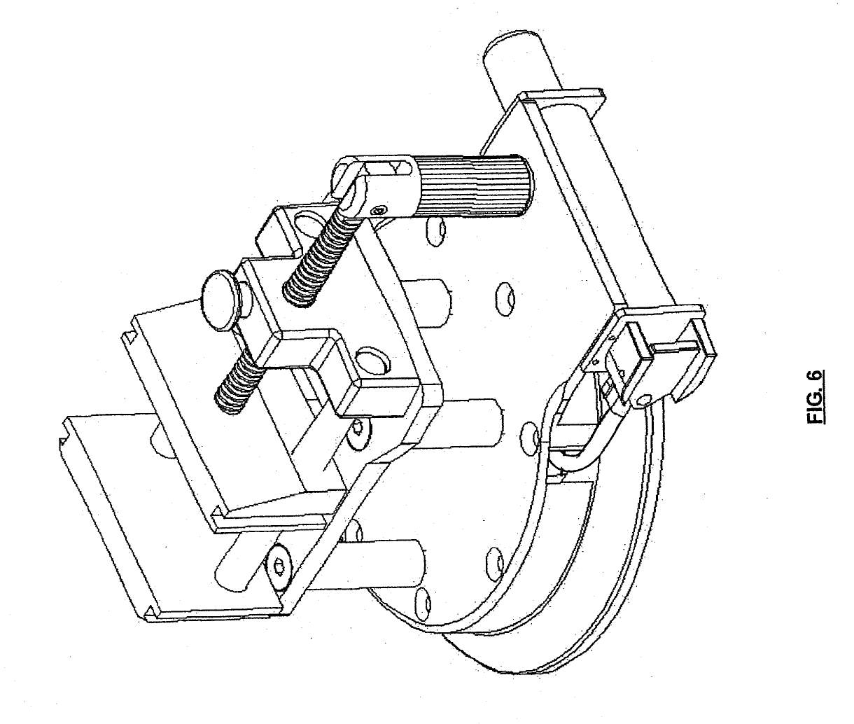

FIGS. 6-10 Alternative Embodiments

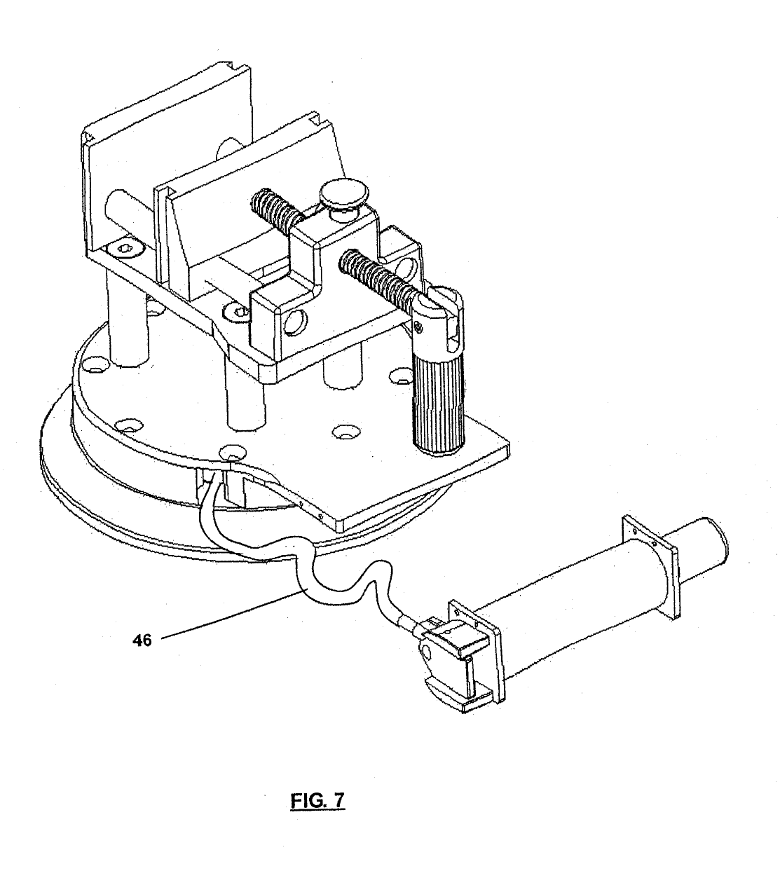

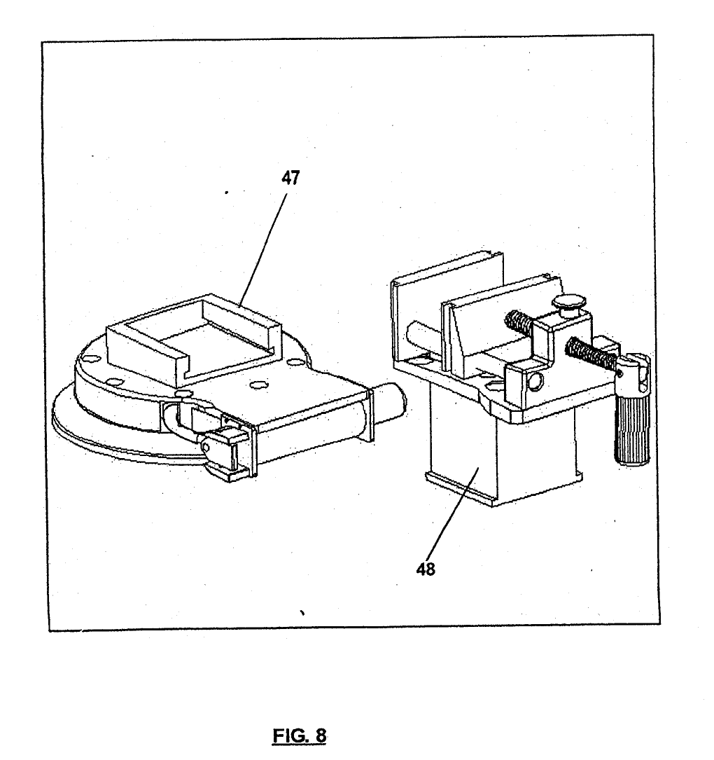

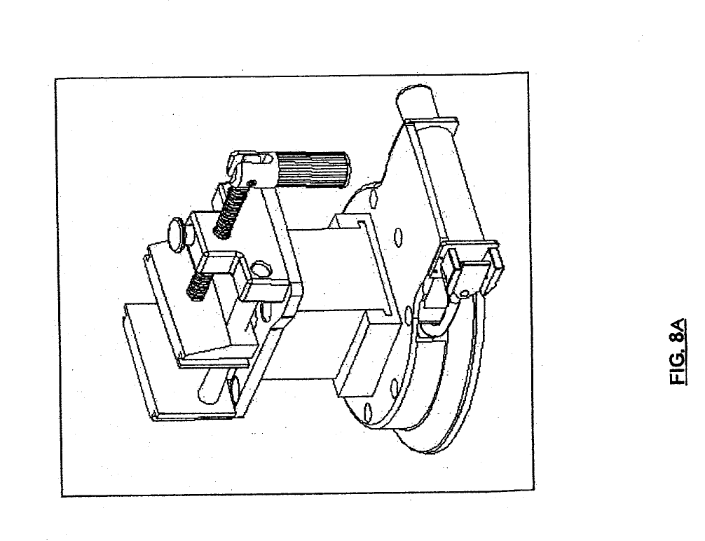

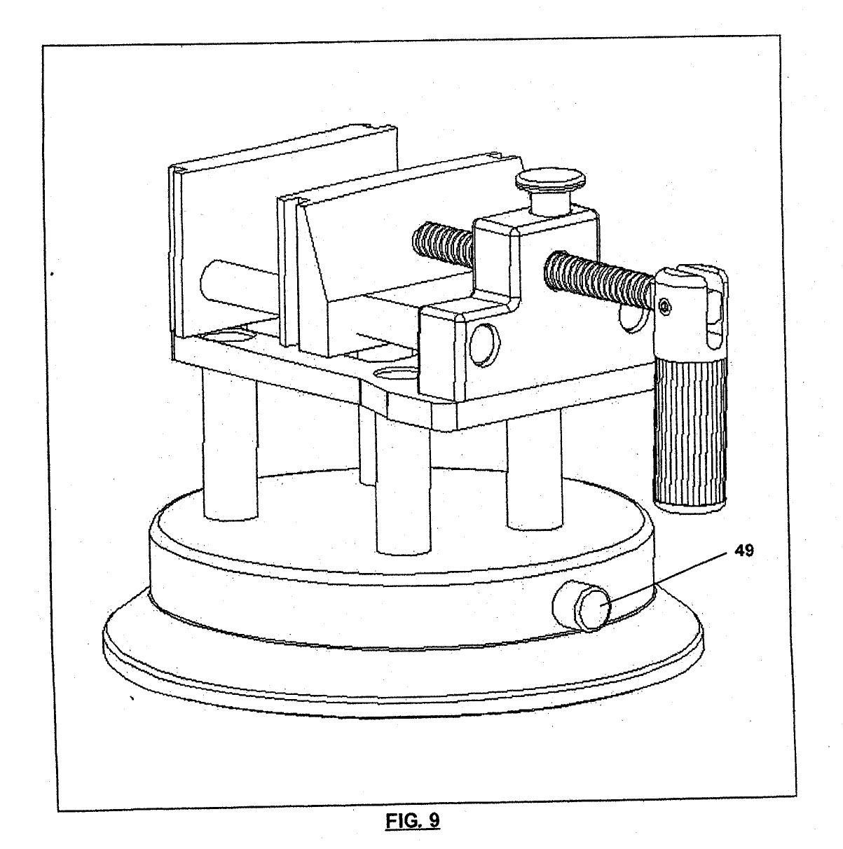

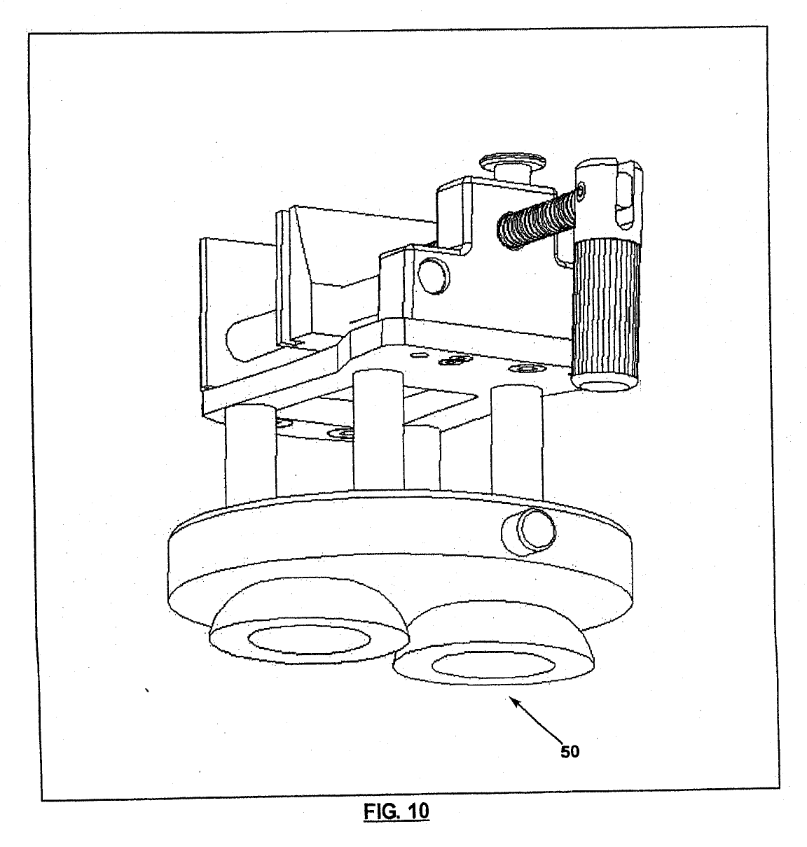

There are various possibilities with regard to the relative position of the vacuum pump. FIG. 6 shows the vacuum pump beneath a protruding ledge on a base plate. Other orientations and locations for the pump are also possible. FIG. 7 shows an embodiment in which the vacuum pump is separated from the clamping mechanism base. A connecting member 46 would allow the pump to evacuate air from and readmit air into the air chamber 41 from a distance. In this embodiment, the pump could also be secured to the base temporarily. A simple check valve might also permit the user to completely disengage the vacuum pump from the clamping mechanism while maintaining a vacuum pressure beneath the vacuum base 22. FIGS. 8a and 8b show an embodiment of the invention wherein the clamping mechanism is a removable element. In this embodiment, the vacuum base 22 could become the foundation for a variety of clamping mechanisms. This would allow manufacturers to make the invention a modular unit. FIG. 9 shows an embodiment of the invention wherein an integral vacuum pump 49 has been integrated into the base plate 36. FIG. 10 shows an embodiment of the invention wherein a plurality of vacuum pads form a vacuum pad array 50 that might better affix the clamping mechanism to the mounting surface. Each vacuum pad in the array 50 could have its own, individual vacuum pump, or one pump could evacuate and readmit air into the entire array 50.

Operation—FIGS. 1-6, 9, 10

In operation one uses the workpiece clamping mechanism 11 in a normal manner. Objects to be worked on are compressed between the clamping jaws 12 and 13. Handle 19 is attached to one end of lead screw 15; the other end of the lead screw is attached to moveable clamping jaw 13. The lead screw 15 is allowed to rotate through the brace block 18 having its threads normally connected to the halfnut 17. The user may elect to depress the halfnut 17 pushing against halfnut spring 44 and thereby disconnect the lead screw 15 from the halfnut 17. They are then free to slide the handle 19, lead screw 15 and moveable clamping jaw 13 as a unit through the brace block 18 along guide shafts 16 for gross spacing adjustment of the clamping jaws 12 and 13. Once the user stops depressing the halfnut 17, the halfnut spring 44 pushes halfnut 17 against lead screw 15 thereby reengaging the threads. The user may then rotate handle 19 to make fine adjustment of the relative positioning of moveable clamping jaw 13. The handle is free to pivot at handle pivot 20, allowing the user to orient handle 19 perpendicular to lead screw 15 and thereby gain greater leverage on the turning of leadscrew 15. A textured surface 21 on handle 19 affords a better grip to the user if their hands are wet, greasy or otherwise unable to easily grip.

To “ground” the vacuum base 22 to mounting surface 23, one simply places the invention on any substantially smooth mounting surface 23. The mounting surface 23 does not have to be perfectly smooth—the invention has been shown to “grip” effectively to mildly textured surfaces. After placing the invention against surface 23, the user manually reciprocates piston 24 in cross tube 25. Each push of the plunger evacuates a small amount of air captured beneath the vacuum pad 35 in air chamber 41 and releases it to the atmosphere. Base pad air seal protrusions 42 running around the perimeter of the vacuum pad 35 effectively create a seal to prevent outside air from replacing the evacuated air. In turn, a very strong vacuum is created beneath the vacuum pad 35. The user knows the maximum vacuum pressure has been reached when the piston no longer protrudes to be pushed in (a spring in the vacuum pump chamber pushes the piston out until the created vacuum pressure overcomes the spring force). This vacuum pressure is indicated with the vacuum pressure level indicator 39 (the user cannot see the indicator 39 when a sufficient vacuum is present). With the evacuated-air-vacuum created, the invention is extremely solidly planted to mounting surface 23. The base plate 36 is rigidly affixed to the vacuum pad 35 with fasteners 29. The clamping mechanism 11 is rigidly affixed above the base plate 36 with fasteners 38 that pass through standoffs 37. With the clamping mechanism 11 thus rigidly connected to the vacuum base 22 which has a solid purchase on the mounting surface 23 all manner of actions can be enacted on a workpiece now held between the clamping jaws 12 and 13 of the invention's workpiece clamping mechanism 11.

Upon completing of the work, the user depresses the finger operated air release valve knob 30 to allow outside air to re-enter the air chamber 41 beneath the vacuum pad 35. This breaks the vacuum and the user can lift the invention off surface mounting surface 23 for transport and/or storage.

Operation—FIGS. 7, 8a, 8b

In the alternative embodiment shown in FIG. 7 the user uses the invention as described above but is permitted to move the vacuum pump a distance from the clamping mechanism, or disengage it entirely. In FIGS. 8a and 8b, the user secures the vacuum base to a mounting surface and can then mount or unmount a removable clamping mechanism.

### CONCLUSION, RAMIFICATIONS AND SCOPE

Accordingly, the reader will see that the vacuum based workpiece holder described herein can be used to quickly, easily, temporarily, and strongly affix a clamping mechanism to any substantially smooth mounting surface. In addition, it allows the user to effectively create a strong “third hand” to safely hold objects that are to be worked on. The gripping force afforded by the invention's vacuum base allows the user to mount the invention to new and novel locations such as vertical surfaces (such as a door) or even inverted, in addition to typical horizontal mounting (on a workbench, table, etc.). The invention achieves high grip force and thus permits the user to conduct operations on the workpiece that require considerable force. Moreover, this high grip—and hence high utility—is achieved in a manner that will not mar or permanently mark the mounting surface.

Although the description herein contains many specificities, these should not be construed as limiting the scope of the invention but as merely providing illustration of some of the presently preferred and alternative embodiments of this invention. Moreover, having thus described the invention, it should be apparent that numerous structural modifications and adaptations may be resorted to without departing from the scope and fair meaning of the invention as set forth hereinabove and as described below by the claims.

Thus the scope of the invention should be determined by the appended claims and their legal equivalents, rather than by the examples given.

1) A device for holding workpieces comprising in combination:
a. a resilient vacuum suction means placed on a mounting surface for evacuating air from said vacuum suction means, thereby fastening by vacuum pressure said vacuum suction means onto said mounting surface;
b. a clamping device connected to said vacuum suction means with clamping members that can be adjusted to hold an object placed between said clamping members;
whereby a user of said device can fasten said vacuum suction means to said mounting surface and thereby create a base for operation of said clamping device.

2) The tool of claim 1 further comprising a vacuum release valve coupled to said vacuum suction means for exhausting the evacuated air between said vacuum suction means and said mounting surface.

3) The tool of claim 2 wherein said vacuum suction means is a suction cup, and wherein said vacuum suction means includes an air pump connected to said cup.

4) The tool of claim 3 wherein said pump is a manually operable pump.
